(19) United States
(12) Patent Application Publication
(10) Pub. No.: US 2008/0114475 A1
(43) Pub. Date: May 15, 2008

(54) System and Method for Developing and Implementing Business Process Support Systems

(76) Inventor: Jan Hendrik Wiersema, Siddeburen (NL)

Correspondence Address: MICHAELSON & ASSOCIATES, P.O. BOX 8489, RED BANK, NJ, 07701, US

(21) Appl. No.: 10/585,799

(22) PCT Filed: Jan. 31, 2005
(86) PCT No.: PCT/EP05/00999

§ 371 Date: Jul. 13, 2006

Related U.S. Application Data
(60) Provisional application No. 60/540,689, filed on Jan. 30, 2004.

(51) Int. Cl. G06F 17/00

(52) U.S. Cl. 700/90

(57) ABSTRACT

The present invention is related to business process support systems. More specifically, a system and method for developing and implementing business process support systems are disclosed.

### FIELD OF THE INVENTION

The present invention is related to business process support systems. More specifically, a system and method for developing and implementing business process support systems are disclosed.

### BACKGROUND OF THE INVENTION

In most companies around the world the operational business processes are supported by one or more computer systems. In such systems all or some of the steps of a particular business process, e.g. “generating monthly invoices”, are supported by a computer program. These computer programs are implemented on different hardware platforms, using different software tools. Often these programs need information from one ore more existing databases, e.g. the names and addresses to address the invoices to, and the amounts to be invoiced.

Usually a new computer system is generated and implemented for each specific business process. This has the disadvantage that within one company a multitude of systems coexists with basically the same functionality, i.e. supporting a business process, but with a different look and feel for the user. Users need education for each system. Another disadvantage is that implementing a completely new system for each business process necessarily involves the participation of expensive specialized consultants for developing and maintaining the system. Each time a business process changes, even a little, the experts have to be involved again.

### Problem Definition

Thus the prior art fails to disclose a system for easily developing, implementing and adapting different business process support systems with the same look and feel.

### Aim of the Invention

The aim of the invention is to provide a generic system for easily developing and implementing various specific business support systems.

### SUMMARY OF THE INVENTION

The present invention provides a system for generating business process support system applications, comprising:

core module containing a generic business process support system;

user interface module containing a generic user interface;

configuration module for providing configuration data to said core module for configuring said business process support system applications.

The advantage of providing a generic core module is that the more complex elements business process support system applications only need to be developed once. After that the actual applications can be configured relatively easily. An advantage of the separate user interface module is that the various applications to be generated with the system according to the invention have the same look & feel for the end user. This means that the user does not need additional education for a new application. He is already familiar with the user interface.

Advantageously the core module comprises a data model of a generic business process support system. In a generic data model all relevant elements of an applications are defined in generic terms, and only need to be configured by a system administrator configuring the actual application. The data model can be used as a checklist for the system administrator, to make sure that he captures all relevant elements of both the tasks of the end user.

A business process support system application might be used to retrieve data from one or more databases or to store data in one or more databases after the user has performed his task. Therefore the core module might be able to communicate data from and to one or more databases in a generic format to and from said user interface module. This had the advantage that the core module communicates with the relevant databases in the required specific format, and both the end user and the system administrator do not need to know these specific formats.

In a further embodiment of a system according to the invention, the configuration module comprises different functional layers, each generating part of said configuration information. These functional layers may be:

a data connection layer, defining relevant fields from the databases;

an information layer, defining how data from the fields forms relevant information for the end user;

a process layer, defining how said information can be used by the end user, and;

an authorization layer, defining the authorisation information of each end user.

The advantage of these different layers is that each layer might be configured by another system administrator, with his own knowledge of and responsibility for the required actual application. This leads to greater flexibility in generating and maintaining applications.

The present invention additionally provides a method for generating business process support system applications, the method comprising the steps of:

defining a generic business process support system data model;

defining a generic user interface for a business process support system;

configuring said business process support system data model and said generic user interface.

Advantageously the configuration step according to a method according to the invention comprises the steps of:

defining relevant fields from relevant tables from relevant databases;

defining how data from said relevant fields forms information for the end user of said business process support system application;

defining how said information can be used by said end user;

defining the authorization of each end user.

### BRIEF DESCRIPTION OF THE DRAWINGS

The present invention will further be explained below with reference to exemplary embodiments illustrated in the accompanying drawings, in which:

FIG. 1 schematically shows an overview of a system according to a preferred embodiment of the invention.

FIG. 2 schematically depicts a data model on which the system of FIG. 1 can be based.

FIG. 3 schematically depicts in more detail one of the possible modules of the system of FIG. 1.

FIG. 4 shows an example of a screen for the end user of an application that is developed with a system of FIG. 1.

### DETAILED DESCRIPTION OF THE INVENTION

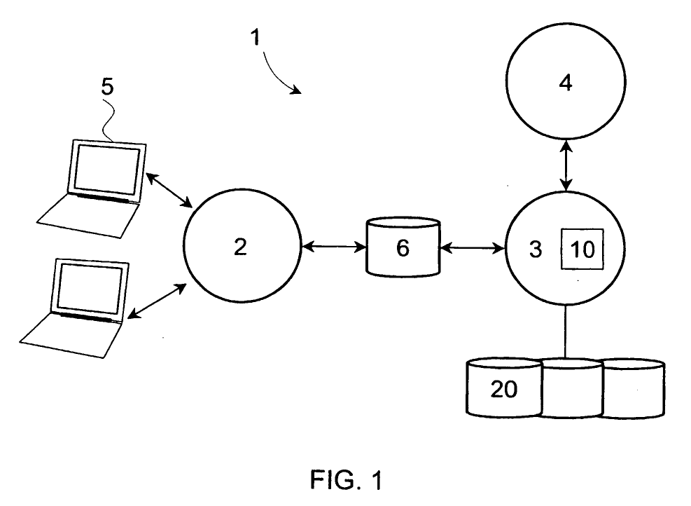

FIG. 1 shows an overview of a system 1 according to the invention. The system can comprise e.g. a configuration module 2, a core module 3 and a user interface module 4.

System 1 can be used to develop specific business process support applications. To enable development of a specific business process support application core module 3 comprises a data model of a generic business process support system. System administrators 5 use configuration module 2 to generate configuration data 6. This configuration data 6 is used by core module 3 to generate a specific application. Core module 3 communicates with user interface module 4 for determining the user interface that is presented to the actual users of a specific application. User interface module 4 comprises a generic concept of a user interface that has to be configured for each specific application. Core module 3 also enables communication with one or more databases 20 which might be used to provide information for a specific application.

The elements of system 1, like but not limited to core module 3, configuration module 2, user interface module 4, configuration data 6 and data bases 20 can be implemented on one physical system, but can also be implemented on separate systems that might communicate with each other over a company network, but also over a public telecommunication network, fixed or wireless.

System 1 can be used to develop specific business process support applications. Such applications support end users in their daily tasks. Usually one business process comprises different tasks that can be carried out by different persons, or by one person with different roles. Furthermore for the performance of a task it is might be needed to retrieve data from one or more databases, and to change data as a result of the task carried out. There might be a relation between a task and elements in a database.

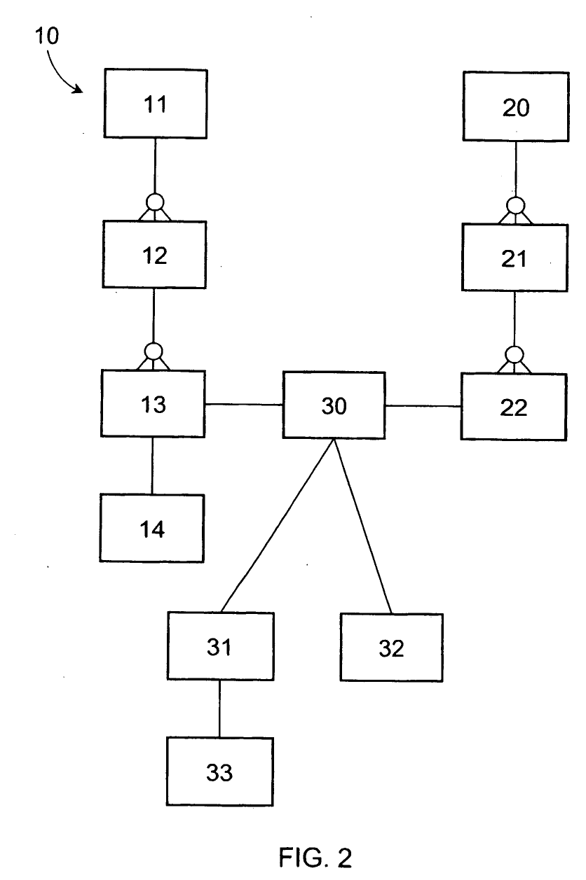

To enable easy development of a specific business process support application, the different modules of system 1 are based on a generic data model of business processes. A data model according to an embodiment of the invention is shown diagrammatically in FIG. 2.

The data model 10 shows the user of the application 11, the user 11 has one or more roles 12. A role can have one or more tasks 13. A task is an overview of menu items in the final application that will be available to the user for performing a task. A task 13 can comprise one or more lists 14. A task 13 can also comprise one or more forms 30.

A form 30 can comprise one or more methods 31 and rules 32.

A method 31 can comprise one or more functions 33. Database 20 can comprise one or more tables 21. A table 21 can comprise one or more fields 22. A field can have a relation with one or more forms 30. So a form 30 is the place where the tasks of an end user of an application interface with a database.

The different elements of system 1 will be discussed in more detail below.

Configuration Module

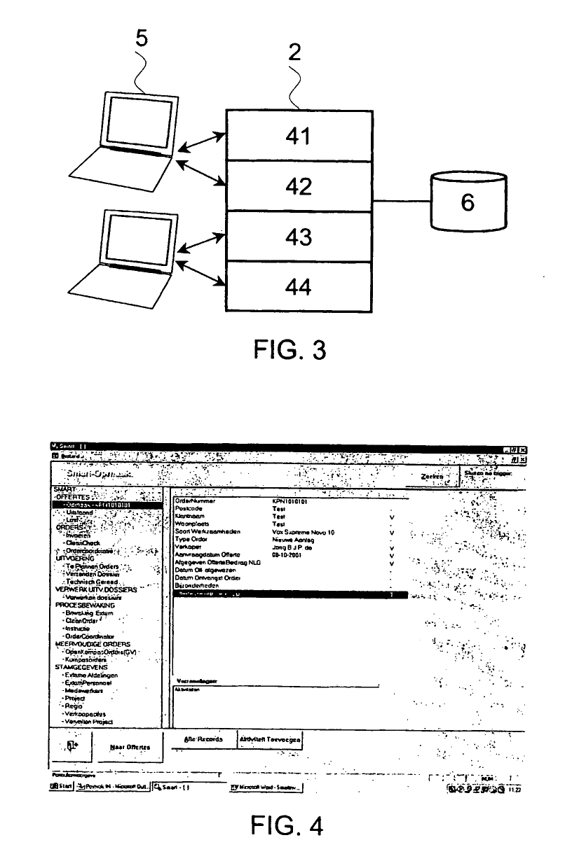

As shown in FIG. 3 configuration module 2 can be used by one or more system administrators 5 to generate configuration information 6. The system administrator 5 will have to fill in all relevant information to enable the core module to generate the application. The configuration module can be divided in one or more functional layers e.g. 41, 42, 43, and 44. Each layer configures part of the final application. The layers can be configured by one or by different system administrators 5. The system administrator might be communicating with the configuration module over a private or public telecommunication network. One or more end users of a final application that is developed with the present system can also function as a system administrator for one or more layers of the system. This might especially advantageously in case of relative minor changes in a particular application, because there is no need to involve a technical expert.

Layer 41 represents the data connection layer of the configuration module 2. This layer is used to identify the databases 20, tables 21 and fields 22 that should be available to this specific application.

Layer 42 represents the information layer of the configuration module 2. This layer is used to identify how the fields 22, selected in layer 41, can be used.

Layer 43 represents the process layer of the configuration module. This layer is used to define the processes that are associated with a specific task. Processes can be defined in terms of functions 33, methods 31 and rules 32 that will be executed on fields 22 of tables 21 of databases 20, that have been selected in the previous layers. In the final application processes will be provided to the user in the user interface in the form of e.g. but not limited to menu items and buttons.

Layer 44 represents the authorization layer of the configuration module. This layer is used to define the authorized users 11 of the final application and their different roles 12 and tasks 13.

User Interface Module

The user interface module 4 comprises a generic design of a user interface. This generic design has to be configured by the core module 3 based on configuration data 6 generated by the configuration module 2. The generic design represents an “empty” user interface, that does not contain any actual data.

The user interface module performs different functions. The user interface module can generate e.g. the menu structure and the forms of an actual application.

The user interface of an actual application can comprise the actual menu structure and forms. With the menu structure the end user can navigate through the application. The menu structure comprises tasks 13 and subtasks. Forms are the elements where the end user performs his actual task. This is the place where he can e.g. read relevant information, obtained from one or more databases, or where he can input information that can be stored as data in one or more databases.

The user interface module takes care of generating the actual user interface, and makes sure that only the relevant information is shown to the user, and the user is only allowed actions in the user interface that he is authorized for in his specific role in the application. The end user is not confronted with a lot of empty fields, or buttons that he cannot actually use. An example of one screen of an actual application is shown in FIG. 4.

Core Module

The core module 3 of system 1 comprises all necessary system logic to build the actual application based on configuration data 6.

The core module builds a menu structure comprising all tasks, subtasks relevant for a specific user with a specific role. The core module gets this information from the configuration module.

The core module is capable of accessing all necessary databases. The core module translates database queries in a generic form, as composed by the configuration module, in actual queries to actual databases. In this way it is not necessary for the end users and the system administrators to know details of the different databases to be used. The core module also translates the data retrieved from one of more databases into information in a generic format which makes it directly interpretable for the end user. It can be that certain information that an end user might need for performing his actual task is formed on the basis of data coming from one or more databases.

The core module can also perform different kinds of validations on the information that the user can input into the system, e.g. by using forms and lists. It will be understood by those skilled in the art that the present invention is not limited to the embodiments illustrated above and that modifications and additions may be made without departing from the scope of the invention as defined in the appending claims.

1. A system (1) for generating business process support system applications, comprising:
core module (3) containing a generic business process support system;
user interface module (4) containing a generic user interface;
configuration module (2) for providing configuration data (6) to said core module (3) for configuring said business process support system applications.

2. A system according to claim 1 wherein said core module (3) comprises a data model (10) of said generic business process support system.

3. A system according to claim 1 wherein said core module (3) is able to communicate data from and to one or more databases (20) in a generic format to and from said user interface module (4).

4. A system according to claim 1 wherein said configuration module (2) comprises different functional layers, each generating part of said configuration information (6).

5. A system according to claim 4 wherein said configuration module (2) comprises:
a data connection layer (41), to generate part of said configuration data (6) defining relevant fields (22) from relevant tables (21) from said databases (20);
an information layer, to generate part of said configuration data (6) defining how data from said fields (22) from said tables (21) of said databases (20) forms relevant information for the end user;
a process layer, to generate part of said configuration data (6), defining how said information can be used by the end user, and;
an authorization layer, to generate part of said configuration data (6) defining the authorisation information of each end user.

6. A method for generating business process support system applications, the method comprising the steps of:
defining a generic business process support system data model;
defining a generic user interface for a business process support system;
configuring said business process support system data model and said generic user interface.

7. A method according to claim 6 wherein the step of configuring comprises the steps of:
defining relevant fields (22) from relevant tables (21) from relevant databases (20);
defining how data from said relevant fields (22) forms information for the end user of said business process support system application;
defining how said information can be used by said end user;
defining the authorization of each end user.
